(19) United States
(12) Patent Application Publication
(10) Pub. No.: US 2022/0092015 A1
(43) Pub. Date: Mar. 24, 2022

(54) PERIPHERAL COMPONENT INTERCONNECT EXPRESS (PCIE) DEVICE ADD-ON CARD DETECTION

(71) Applicant: Hewlett-Packard Development Company, L.P., Spring, TX (US)

(72) Inventors: Ming-Chang Hung, Taipei City (TW); Chia-Cheng Lin, Taipei City (TW); Tai-An Lin, Taipei City (TW); Tsue-yi Huang, Taipei City (TW)

(73) Assignee: Hewlett-Packard Development Company, L.P., Spring, TX (US)

(21) Appl. No.: 17/419,501

(22) PCT Filed: Jun. 10, 2019
(86) PCT No.: PCT/US2019/036392

§ 371 Date: Jun. 29, 2021

(51) Int. Cl. G06F 13/42; G06F 13/20

(52) U.S. Cl. CPC G06F 13/4221; G06F 2213/0024; G06F 13/20

(57) ABSTRACT

The present specification describes a method. The method including: detection of at least one General Purpose Input Output (GPIO) pin on a Peripheral Component Interconnect Express (PCIe) device; and presenting, on the at least one GPIO pin, during a Basic Input Output System (BIOS) phase prior to a DXE phase, a signal indicating a presence of a card on the PCIe device.

### BACKGROUND

Computing trends continue to include devices and cards supported by a processor. One type of add-on devices are Peripheral Component Interconnect Express (PCIe) devices.

### BRIEF DESCRIPTION OF THE DRAWINGS

The accompanying drawings illustrate various examples of the principles described herein and are a part of the specification. The illustrated examples do not limit the scope of the claims.

FIG. 1 shows a flowchart of a method of detecting a PCIe add-on card consistent with this specification.

FIG. 2 shows a Peripheral Component Interconnect Express (PCIe) device consistent with this specification.

FIG. 3 shows a Peripheral Component Interconnect Express (PCIe) device consistent with this specification.

FIG. 4 shows a flowchart of a method consistent with this specification.

FIG. 5A shows a flowchart for a method of identifying a card on a PCIe device during a PEI phase of loading a BIOS.

FIG. 5B shows a flowchart for activity in the DXE phase following FIG. 5A.

FIG. 6 shows a layout of the memory space in an example consistent with this specification.

FIG. 7 shows a workflow for early phases on startup.

Throughout the drawings, identical reference numbers designate similar, but not necessarily identical, elements. The figures are not necessarily to scale, and the size of some parts may be exaggerated or minimized to more clearly illustrate the example shown. The drawings provide examples and/or implementations consistent with the description. However, the description is not limited to the examples and/or implementations shown in the drawings.

### DETAILED DESCRIPTION

Computing systems support Peripheral Component Interconnect Express (PCIe) slots to receive various PCIe add-on card(s), which add-on cards provide functionality to the computing system. In general, a PCIe add-on card will be detected and assigned PCIe resources during a Driver Execution Environment (DXE) phase based on the PCI bus enumeration mechanism.

In some cases, the add-on card for a PCIe device needs to be assigned PCIe resources in an earlier phase, for example, during the Pre-EFI Initialization (PEI) phase. Waiting until the DXE phase may increase the time to detect an add-on card and may cause insufficient allocation of resources to support the card. Further, allocating resources for the card when the card is not present also wastes resources and time. Accordingly, the present specification describes a mechanism to detect if a specific PCIe device add-on card is connected or not and to run specific BIOS settings in an early phase based on the detected presence or lack thereof.

The described approach can detect a specific PCIe device add-on card through device detection on a General Purpose Input Output (GPIO) pin in a BIOS Power On Self Test (POST) phase and can then run different BIOS settings based on the presence or absence of the PCIe device and/or card. Failing to run card specific BIOS operations when a card is present may result in the card being non-functional until later in startup. Including the card specific BIOS in every startup risks wasting time and PCIe resources.

Basic Input Output System (BIOS) is the first application executed by a computing system during startup. BIOS provides testing of the system components, testing of basic input and output controls, and bootstrapping of the operating system. BIOS is made up of multiple phases, including a Power On Self Test (POST). Under the newer, Unified Extensible Firmware Interface (UEFI) structure, BIOS operations include other phases such as Security (SEC), Pre-EFI Initialization Environment (PEI), Driver Execution Environment (DXE), Boot Device Selection (BDS), and/or Transient System Load (TSL) prior to the runtime environment. In some cases, it is desirable to allocate additional resources for an add-on card on a PCIe device prior to the DXE phase.

Returning to the various phases, the POST phase identifies, and initializes system devices such as the central processing unit (CPU), memory, e.g., Random Access Memory (RAM), interrupt and Direct Memory Access (DMA) controllers and other parts of the chipset, video display card, keyboard, hard disk drive, optical disc drive and other basic hardware.

The Security (SEC) phase runs a pre-verifier. The pre-EFI initialization (PEI) phase of execution has two roles in a platform's life: determining the source of the restart and providing a minimum amount of permanent memory for the ensuing Driver Execution Environment (DXE) phase. The pre-EFI phase may provide for CPU initialization, chipset initialization, and/or board initialization. The DXE phase executes drivers to make the associated devices operable and ready to interact with the rest of the system.

In previous computing systems, the system memory map includes physical memory, e.g., Memory Mapped Input Output (MMIO), resources for a PCIe device. The PCIe device MMIO resource may be allocated in two parts. The BIOS will decide total PCIe Memory Map I/O Range (MMIO) during the PEI phase. Normal MMIO range is fixed at this point of the PEI phase. System memory map will be decided in PEI phase. In contrast, individual PCIe devices will be assigned MMIO resources during PCI Bus enumeration in the DXE phase.

This two-part allocation may result in problems. For example, specific PCIe devices will allocate more MMIO resource to support PCIe card specific purposes, such as a Thunderbolt™ PCIe card (Hot plug) and/or Nvidia™ VGA card (Graphics performance). In a desktop (DT) system, the MMIO region will be pre-defined. The DT system's support for additional PCIe cards will be limited and lacks flexible capability. On the other hand, if the MMIO size(s) is pre-defined to be larger, the usable memory will be smaller and memory may be wasted.

The present specification allows for optimized MMIO resource allocation during early phases of BIOS, i.e., pre-DXE, to support a PCIe device and to optimize usable memory. In this example, the system, during BIOS, will determine a system memory map (which includes the total PCI memory map I/O Range) in the PEI phase. Specific PCIe card MMIO ranges will be detected using a GPIO pin. After the PEI phase, the BIOS operation will hand over the system memory map during the DXE phase. During PCI Bus enumeration in the DXE phase, the PCIe device will have MMIO resources assigned based on the system memory map generated during PEI.

As used in this specification and the associated claims, the term PCIe device describes a device which has memory allocated during the PEI phase of BIOS. The term card or add-on card refers to a component added to a PCIe device to modify its function. The base PCIe device may be referred to as a card. The base PCIe device may be a board or other type of device. The add-on card may be a card, a chip, or another type of device capable of modifying the behavior of the associated PCIe device. The terms device and card are used this way to provide consistency of the card interfacing with the device which in turn interfaces with the system.

Among other examples, this specification describes a method including: detecting at least one General Purpose Input Output (GPIO) pin on a Peripheral Component Interconnect Express (PCIe) device; and presenting, on the at least one GPIO pin, during a Basic Input Output System (BIOS) phase prior to a DXE phase, a signal indicating a presence of a card on the PCIe device.

Among other examples, this specification also describes a PCIe device that includes a card to be attached to the PCIe device. The device also includes a General Purpose Input Output (GPIO) pin. The GPIO pin includes a datum that, during a Power On Self Test (POST) phase of a BIOS, indicates the card is attached to the PCIe device.

This specification also describes a method of allocating resources to support a card on a Peripheral Component Interconnect Express (PCIe) device, including: during a pre-EFI initialization (PEI) phase of a Basic Input Output System (BIOS), detecting a presence of a card inserted into the PCIe device based on a signal received from a General Purpose Input Output (GPIO) pin; and loading a BIOS based on detecting the GPIO pin on the PCIe device.

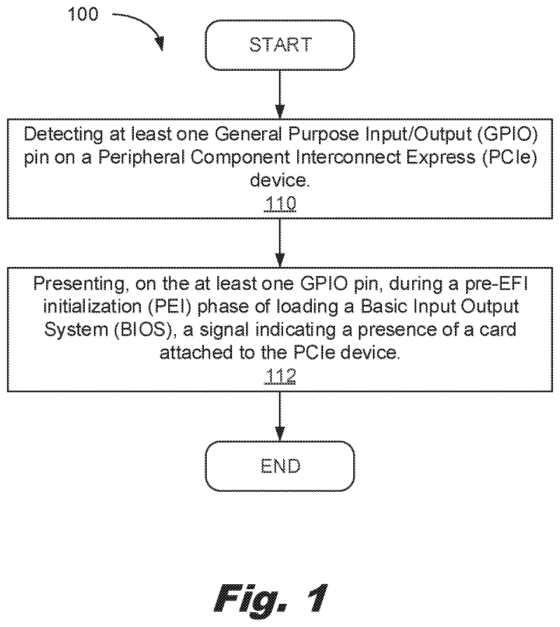

Turning now to the figures, FIG. 1 shows a method (100) consistent with this specification. The method (100) includes: detecting (110) at least one General Purpose Input Output (GPIO) pin on a Peripheral Component Interconnect Express (PCIe) device; and presenting (112), on the at least one GPIO pin, during a Basic Input Output System (BIOS) phase prior to a DXE phase, a signal indicating a presence of a card on the PCIe device.

The method (100) improves the provision of system resources to an add-on card on a PCIe device. Normally, resources for a card are not allocated until later in the BIOS.

According to the method (100), at least one General Purpose Input Output (GPIO) pin is detected (110) on a Peripheral Component Interconnect Express (PCIe) device. The pin may detect high to indicate the presence of an add-on card. Alternately, the pin may detect low to indicate the presence of the add-on card.

The method (100) includes presenting (112), on the at least one GPIO pin, during a Basic Input Output System (BIOS) phase prior to a DXE phase, a signal indicating a presence of a card on the PCIe device. In an example, the signal is presented during the POST phase of loading the BIOS. The signal may be presented during a PEI phase of loading the BIOS.

In some examples, a plurality of GPIO pins is used to convey the presence of the card on the PCIe device. The plurality of pins may identify a type of card. The plurality of pins may be used to hold an identifier for the type of add-on card on the PCIe device. This may be used, for example, to determine whether to release the assigned memory in later BIOS phases. The plurality of pins may identify an amount of a resource to be allocated to support the card, e.g., an amount of memory.

The method (100) may further include loading a first set of instructions based on the signal. The method (100) may include allocating resources for the card based on the signal. In some examples, a second set of instructions is loaded in place of the first set of instructions if the signal is not detected on the GPIO pin.

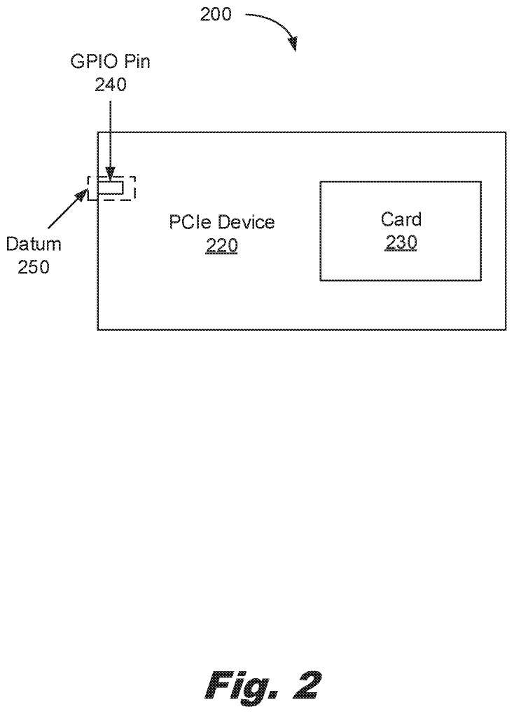

FIG. 2 shows a Peripheral Component Interconnect Express (PCIe) device (220) consistent with this specification. The PCIe device (220) includes: a card (230) to be attached to the PCIe device (220); and a General Purpose Input Output (GPIO) pin (240) that includes, during a Power On Self Test (POST) phase a BIOS, a datum (250) indicating the card is attached to the PCIe device.

The Peripheral Component Interconnect Express device (220) provides a signal on a GPIO pin during the POST phase of the BIOS when a card (230) is present on the device (220). The signal allows the system to load a first set of instructions reflecting the presence of the card (230) instead of a second set of instructions for when no card (230) is present. The first set of instructions may allocate a first amount of MMIO memory for an add-on card. The second set of instructions may allocate a second amount of memory for the add-on device without the add-on card.

PCIe devices (220) have pairs of electrical connections to provide signals. A pair of electrical connections on a PCIe device may also be referred to as a lane. A PCIe device (220) may have 1, 4, 8, 16, 32, and/or some other number of lanes. Generally speaking, devices with fewer lanes are compatible with ports which may accommodate more lanes. A lane or multiple lanes may serve as the GPIO pin (240) for the described approach.

The add-on card (230) may be a supplemental card (230) electrically connected to the PCIe device (220). The add-on card (230) may provide additional capabilities to the PCIe device (220) and/or an associated system.

The General Purpose Input Output (GPIO) pin (240) holds a datum (250) indicating the presence of the add-on card (230) on the PCIe device (220). This occurs during an early part of loading of a BIOS. In an example, the early part of BIOS is the POST phase of the BIOS. In another example, the early part of BIOS is the PEI phase of the BIOS.

In some examples, a single GPIO pin (240) is used. In other examples, multiple GPIO pins (240) are used to present multiple datum (i.e., data). The multiple GPIO pins (240) may identify the presence of multiple cards (230). The data (250) on the multiple GPIO pins (240) may identify an amount of resources needed by the add-on card (230). The data (250) on the multiple GPIO pins (240) may identify the type of add-on card (230) on the PCIe device (220). The datum (250) on the GPIO pin (240) signals the presence of the add-on card (230) on the PCIe device (220).

In some examples, individual pins are used to indicate multiple add-on cards (230). In some examples, the pins are used to convey a setting which indicates a number of add-on cards (230). For example, two pins may each be held high to indicate a respective add-on card (230). In another example, the two pins may be used to indicate a setting of 10 to indicate the presence of two add-on cards (230), a setting of 01 to indicate one add-on card (230), and a setting of 00 to indicate no add-on cards (230).

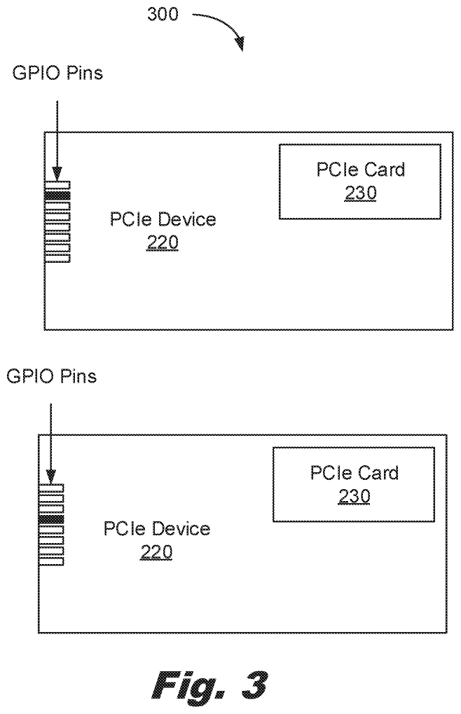

FIG. 3 shows a system (300) of PCIe devices (220) consistent with this specification. The PCIe devices (220) each include: an add-on card (230) to be inserted into the PCIe device (220); and multiple General Purpose Input Output (GPIO) pins (240).

In an example, the PCIe device (220) presents data (250) on multiple GPIO pins (240) during an early phase of BIOS, such as during the POST phase. The PCIe device (220) may present a single datum (250) on a single GPIO pin (240). The datum (250) indicates the presence of the add-on card (230) on the PCIe device (220). This allows an associated system to detect the add-on card (230) and allocate a resource, e.g., memory, for the add-on card (230) during early phases of the BIOS. This, in turn, allows different and additional functionalities to be provided by the add-on card (230), especially during loading of the BIOS. In some examples, the BIOS settings loaded depend on whether or not the datum (250) on the GPIO pin (240) is detected. In some examples, the presence of the datum (250) loads a first set of instructions in place of a second set of instructions loaded when the datum (250) is not present. For example, a first BIOS setting may be loaded if the add-on card (230) is detected as present and a second BIOS setting loaded if the add-on card (230) is not detected. The first or second BIOS setting may be loaded during the POST phase. In an example, the first BIOS setting allocates a resource to support the card (230).

In some examples, there are multiple add-on cards (230). The same principles may be readily expanded to cover multiple add-on cards (230). For example, multiple GPIO pins (240) may be used to indicate the multiple add-on cards (230). Multiple GPIO pins (240) may be used to identify a BIOS setting and/or sets of instructions to support the multiple add-on cards (230).

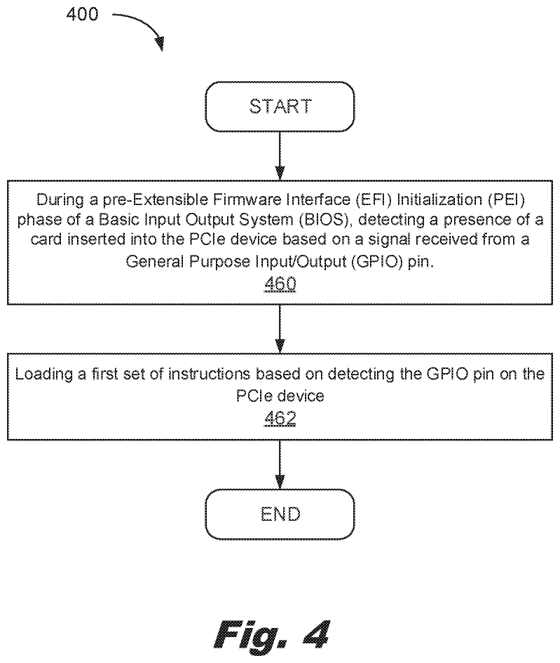

FIG. 4 shows a flowchart of a method (400) of allocating resources to support an add-on card (230) on a Peripheral Component Interconnect Express (PCIe) device (220) consistent with this specification.

The method (400) includes during a pre-EFI initialization (PEI) phase of a Basic Input Output System (BIOS) operation, detecting (460) a presence of a card (230) inserted into the PCIe device (220) based on a signal received from a General Purpose Input Output (GPIO) pin (240). As discussed above, multiple GPIO pins (240) may be used. The GPIO pins (240) may signal additional information beyond the presence of the card (230). The GPIO pins (240) may indicate an amount of memory to be reserved. The GPIO pins (240) may indicate multiple add-on cards (230) are present. The method (400) may also include detecting a plurality of GPIO pins (240) wherein the plurality of GPIO pins (240) identify the card (230) on the PCIe device (220).

The method (400) includes loading (462) a BIOS setting based on detecting the GPIO pin (240) on the PCIe device (220). The loaded BIOS setting may allocate resources for the add-on card (230). The loaded BIOS setting may inform the DXE driver about the allocation of resources to the card (230). The method (400) may also include allocating resources for an add-on card (230) on the PCIe device (220) during a PEI phase of the loaded BIOS.

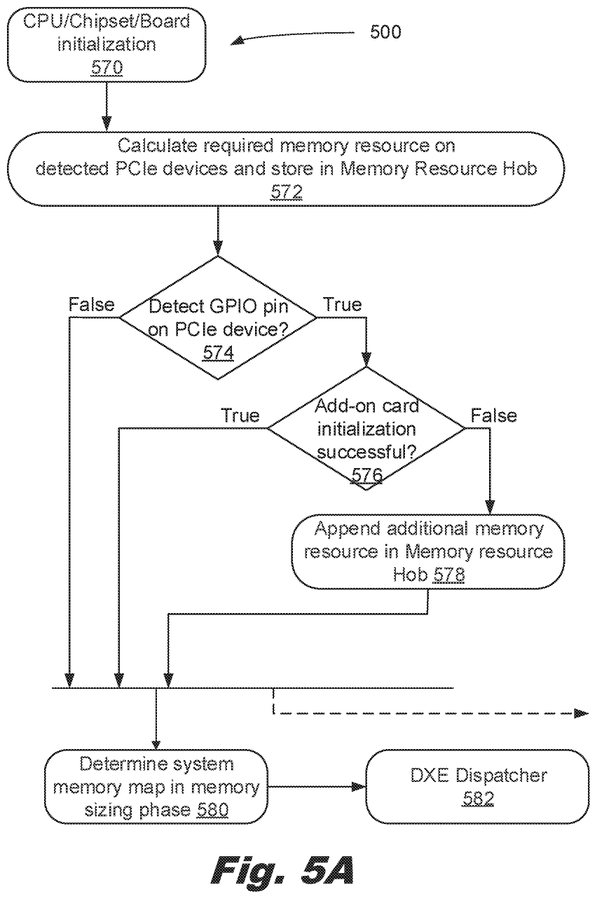

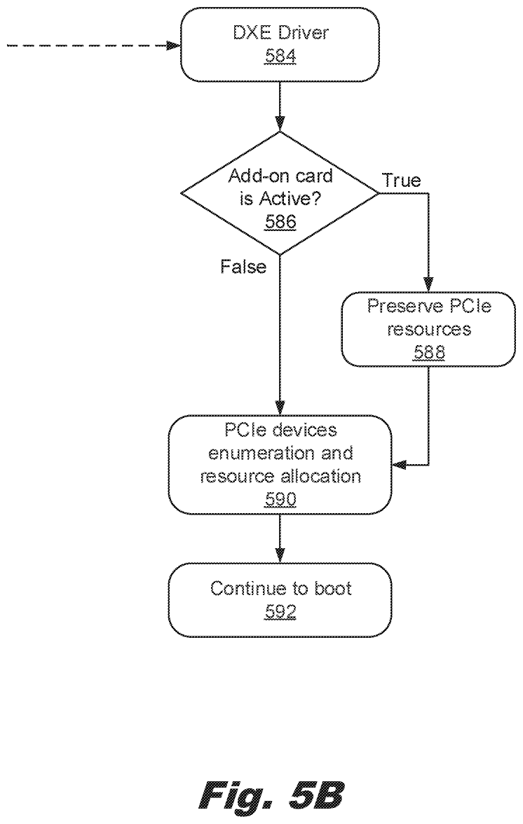

FIG. 5A shows a flowchart for a method (500) of identifying an add-on card (230) on a PCIe device (220) during a PEI phase of loading a BIOS. FIG. 5B shows a flowchart for activity in the DXE phase following FIG. 5A. The method (500) includes: CPU/Chipset/Board initialization (570); Calculate (572) required memory resource on detected PCIe devices and store in Memory Resource HOB; Detect (574) GPIO pin on PCIe device; Add-on card initialization successful (576); Append (578) additional memory resource in Memory Resource HOB; Determine (580) system memory map in memory sizing phase; DXE dispatcher (582); DXE driver (584); Add-on card active? (586); Preserve (588) PCIe resources; PCIe devices enumeration (590) and resource allocation; and Continue to boot (592)

The method (500) includes CPU/Chipset/Board initialization (570). On power on, the processor, chipset, and/or motherboard of the system are initialized. This activity may be part of the PEI phase.

Calculate (572) required memory resource on detected PCIe devices and store in Memory Resource HOB. This step accounts for the PCIe devices (220) detected but may not account for any cards (230) on the PCIe devices (220) which may require additional resources.

The method (500) includes detect (574) GPIO pin (240) on a PCIe device (220). The pin (240) contains a datum indicating the presence or absence of a card (230) on the PCIe device (220). If the datum indicates an add-on card (230) is present, then the add-on card is initialized. If the datum indicates no add-on card (230) is present, then the system proceeds to determine system memory map in the memory sizing phase (580).

If the add-on card initialization successful (576), then the system proceeds to determine system memory map in memory sizing phase (580). If the initialization is unsuccessful, then an additional memory resource is appended (578) in the memory resource HOB and a notification is provided for the DXE driver (584). This notification is indicated by a dashed arrow that is continued in FIG. 5B.

Determine (580) system memory map in memory sizing phase. The system during memory sizing accounts for the memory resources to be allocated in the Hand off block (HOB).

DXE dispatcher (582) advances the system to the DXE phase.

DXE driver (584) controls the normal allocation of resource for the PCIe device. However, the driver (584) may be notified that additional resources are needed (dashed arrow from 578).

The system determines if the add-on card (230) is active? (586). If the add-on card (230) is active, the system may preserve the PCIe resources previously allocated for the card during the PEI phase. In other cases, the previously allocated resources may no longer be needed and the normal PCIe devices enumeration and resources allocation (590) may proceed without preserving the previously allocated PCIe resources.

After the resources have been allocated, the system continues to boot (592) using normal processes.

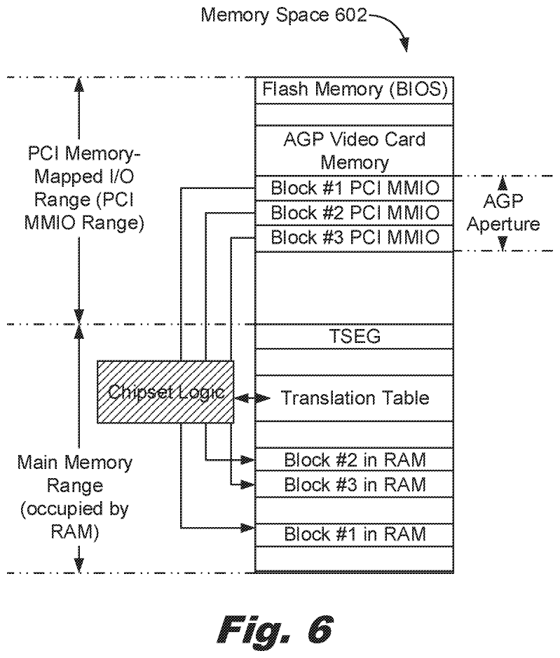

FIG. 6 shows a layout of the memory space (602) in an example consistent with this specification. The memory space (602) is partitioned into the PCI Mapped Memory Input Output Range (PCI MMIO) and the main memory range (RAM). Within the PCI MMIO is the Accelerated Graphics Port (AGP) aperture which contains the MMIO portions of the PCI devices (220). Blocks are shown for three devices (220) in this example. The devices (220) also have a RAM block allocated to support their operation. The RAM blocks are managed by the Hand Off Block (HOB), also known as the translation table, and as administered by the chipset. Accordingly, while RAM may be allocated and reallocated during subsequent operations, the ability to modify the AGP aperture is fixed in the PEI phase. So, if an add-on card (230) on a PCIe device (220) will require MMIO in the AGP aperture, this memory needs to be allocated during a pre DXE phase in order for the aperture to be suitably sized. Accordingly, sensing a GPIO pin (240) in order to detect the card (230) during a pre-DXE phase allows suitable sizing of the aperture to accommodate all the PCI devices and their associated cards (230).

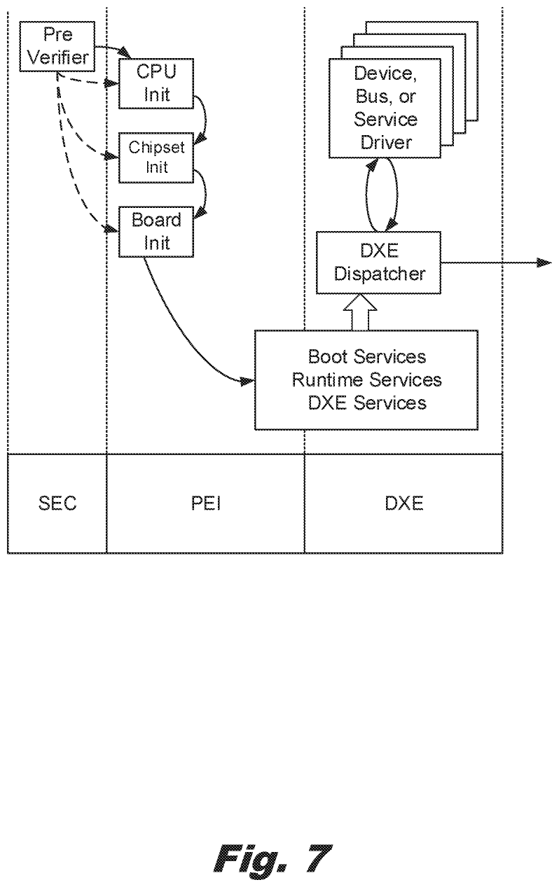

FIG. 7 shows a workflow for early phases on startup. The first phase, security (SEC) includes verification of the various devices, e.g., the central processing unit (CPU), chipset, board, etc. The second phase (PEI) starts with initializing the CPU, chipset, and board. The phase then transitions to boot services, runtime services, and DXE services. The phase also transitions to the Driver Execution Environment (DXE). In the DXE phase, the dispatcher prepares the various drivers, buses, etc. to operate. Control is then passed to the Boot dispatcher in the Boot Device Selection (BDS) phase.

It will be appreciated that, within the principles described by this specification, a vast number of variations exist. It should also be appreciated that the examples described are only examples, and are not intended to limit the scope, applicability, or construction of the claims in any way.

What is claimed is:

1. A method comprising:
detecting at least one General Purpose Input Output (GPIO) pin on a Peripheral Component Interconnect Express (PCIe) device; and
presenting, on the at least one GPIO pin, during a Basic Input Output System (BIOS) phase prior to a Driver Execution Environment (DXE) phase, a signal indicating a presence of a card attached to the PCIe device.

2. The method of claim 1, further comprising loading a first set of instructions based on the signal.

3. The method of claim 1, wherein the presenting, on the at least one GPIO pin, during BIOS phase prior to a DXE phase, a signal indicating a presence of a card on the PCIe device occurs during a Power On Self Test (POST) phase.

4. The method of claim 1, wherein the at least one GPIO pin comprises a plurality of GPIO pins.

5. The method of claim 1, wherein the signal further identifies the card.

6. A Peripheral Component Interconnect Express (PCIe) device comprising:
a card to be attached to the PCIe device; and
a General Purpose Input Output (GPIO) pin comprising, during a Power On Self Test (POST) phase of a BIOS, a datum indicating the card is attached to the PCIe device.

7. The device of claim 6, wherein the PCIe device comprises a plurality of GPIO pins comprising a plurality of datum, the plurality of datum indicating information about the card.

8. The device of claim 6, wherein a first set of instructions loaded to the PCIe device depends on the datum on the GPIO pin.

9. The device of claim 8, wherein the first set of instructions is loaded during the POST phase.

10. The device of claim 9, wherein the first set of instructions loaded during the POST phase allocates a resource of the PCIe device used by the card.

11. The device of claim 9, wherein the first set of instructions loaded during the POST phase allocates a resource of the PCIe device used by the card during the POST phase based on a presence of the card on the PCIe device.

12. The device of claim 6, wherein an absence of a card on the PCIe device is indicated with the datum on the GPIO pin.

13. A method of allocating resources to support a card on a Peripheral Component Interconnect Express (PCIe) device, comprising:
during a pre-Extensible Firmware Interface (EFI) Initialization (PEI) phase of a Basic Input Output System (BIOS), detecting a presence of a card inserted into the PCIe device based on a signal received from a General Purpose Input Output (GPIO) pin; and
loading a first set of instructions based on detecting the GPIO pin on the PCIe device.

14. The method of claim 13, wherein loading the first set of instructions based on detecting the GPIO pin on the PCIe device comprises allocating resources for a card on the PCIe device during the PEI phase of the BIOS.

15. The method of claim 13, wherein detecting a presence of a card inserted into the PCIe device based on a signal received from a GPIO pin comprises detecting a plurality of GPIO pins wherein the plurality of GPIO pins identify the card on the PCIe device.
